(19) United States
(12) Patent Application Publication
(10) Pub. No.: US 2009/0076878 A1
(43) Pub. Date: Mar. 19, 2009

(54) EFFICIENT PROJECT STAFFING

(76) Inventors: Matthias Woerner, Dielheim (DE); Stephan Ilg, Tiefenbach (DE); Georg V. Heryschek, Mannheim (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/857,671

(22) Filed: Sep. 19, 2007

(51) Int. Cl. G06Q 10/00

(52) U.S. Cl. 705/9

(57) ABSTRACT

A system may include reception of an indication of a user interface event, determination of an instruction to assign a person to a task based on the user interface event, calling of a service of a user interface controller object to assign the person to the task based on the determined instruction, calling of a service of a business object associated with the task to assign the person to the task, update of the business object to assign the person to the task, synchronization of the user interface controller object with the updated business object, and generation of a user interface to present a Gantt chart representing the updated business object.

### FIELD

Some embodiments relate to project planning systems. More specifically, some embodiments concern graphical assignment of staff members to a project.

### BACKGROUND

Conventional enterprise architectures include a user interface layer for presenting back-end information to a user. The user interface layer may consist of a portal or other application which includes proprietary mechanisms for communicating with business objects of an application layer. The user interface layer receives information related to the business objects from the application layer and presents the information to the user.

The above-mentioned proprietary mechanisms are typically required to support a communication protocol between the user interface layer and the application layer. Moreover, the proprietary mechanisms control the formatting of business object information into graphical elements of a user interface. Business objects currently used in business applications therefore do not efficiently interact with the user interface layer. In some systems, a business object may be mapped into graphical elements in order to improve compatibility between the business object and a user interface. These systems exhibit a slow response time due to the required mapping.

A system to facilitate presentation of back-end business information within a web browser is described in commonly-assigned and co-pending U.S. patent application Ser. No. ______, entitled “System and Method of Communicating Between Heterogeneous Systems”, filed on ______, 2007 (Attorney Docket No. 2007E00079US), the contents of which are incorporated herein for all purposes. Such a system provides a general framework for addressing the foregoing, but further improvements are desired to manage various usage scenarios. For example, efficient systems for assigning people to particular tasks and for graphically displaying the results of such assignment are desired.

### BRIEF DESCRIPTION OF THE DRAWINGS

FIG. 1 comprises a block diagram of an architecture according to some embodiments.

FIG. 2 is a flow diagram of a process according to some embodiments.

FIG. 3 comprises a block diagram of an architecture according to some embodiments.

FIG. 4 is an outward view of a user interface according to some embodiments.

FIG. 5 is an outward view of a user interface according to some embodiments.

FIG. 6 is a diagram to illustrate a process according to some embodiments.

FIG. 7 is diagram illustrating a Project business object according to some embodiments.

FIG. 8 is an outward view of a user interface according to some embodiments.

FIG. 9 is an outward view of a user interface according to some embodiments.

FIG. 10 is an outward view of a user interface according to some embodiments.

FIG. 11 is an outward view of a user interface according to some embodiments.

FIG. 12 is an outward view of a user interface according to some embodiments.

FIG. 13 is an outward view of a user interface according to some embodiments.

FIG. 14 is an outward view of a user interface according to some embodiments.

FIG. 15 is an outward view of a user interface according to some embodiments.

### DETAILED DESCRIPTION

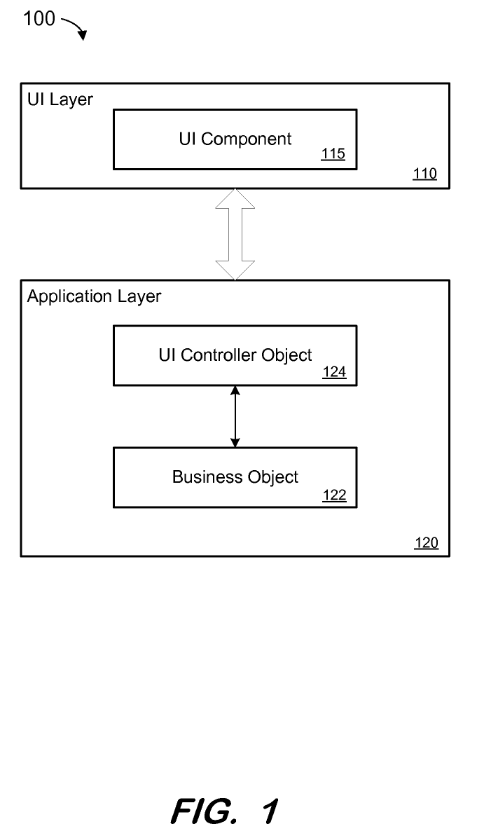

FIG. 1 comprises a block diagram of architecture 100 according to some embodiments. Architecture 100 may provide graphical user access to back-end business data. Architecture 100 may represent any combination of hardware and software elements, and various hardware and software elements of architecture 100 may be located in disparate locations.

UI layer 110 of architecture 100 includes UI component 115 for displaying a user interface to a user. UI component 115 may also detect user manipulation of the user interface and transmit an indication of a user interface event to application layer 120 based on the detected manipulation. UI component 115 may communicate with application layer 120 via any protocol(s), including but not limited to services-based protocols. According to some embodiments, UI component 115 comprises a Java® applet executed by a Java Execution Engine.

Application layer 120 includes business object 122 and UI controller object 124. According to some embodiments, application layer 120 comprises program code of SAP Enterprise Portal® and SAP Web Application Server®. Business object 122 may comprise business logic and/or data having any suitable structure. Business object 122 may encapsulate data received from back-end systems. According to some embodiments, application layer 120 comprises software connectors to several different types of data sources. For example, application layer 120 may support any of the protocols in the following non-exhaustive list: Java Database Connectivity (JDBC), SAP Java Connector (JCO), P4, and Simple Object Access Protocol (SOAP).

In business software environments, such as in enterprise service architecture systems, business objects can be defined according to a node structure that may specify corresponding data elements and behaviors to be associated with the business objects. A business object may include nodes, attributes, queries and actions. Development of a business software environments may involve defining an object model that specifies interrelationships of business objects to be implemented in an application framework.

Business object 122 may communicate with UI controller object 124 via enterprise services-based communication. UI controller object 124 may therefore call services of business object 122 and expose its own services to UI layer 110. The services exposed by UI controller object 124 may be supported by calls to the services of business object 122. For example, UI component 115 may use the services exposed by UI controller object 124 to generate user interface elements related to the data and logic of business object 122. Business object 122 and UI controller object 124 may be implemented in ABAP®, but embodiments are not limited thereto.

According to some examples of operation, UI controller object 124 receives an indication of a user interface event from UI layer 110 and calls an appropriate service of business object 122 based on the user event. Business object 122 updates itself based on the service call and UI controller object 124 generates user interface elements corresponding to the update. UI controller object 124 then transmits the user interface elements to UI component 115 for subsequent display to a user.

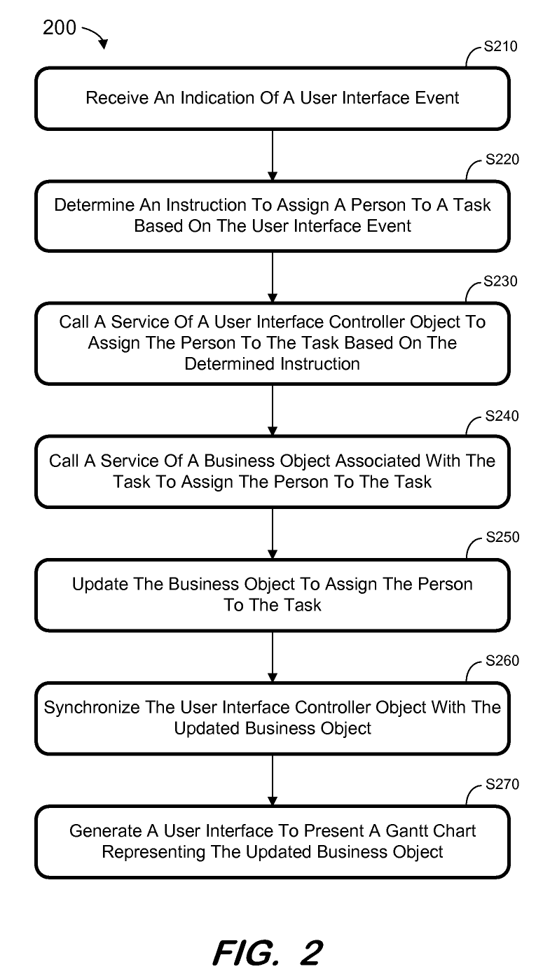

FIG. 2 is a flow diagram of process 200 according to some embodiments. Some embodiments of process 200 may be implemented by architecture 100 of FIG. 1. Embodiments are therefore not limited to any specific combination of hardware and software.

Process 200 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments.

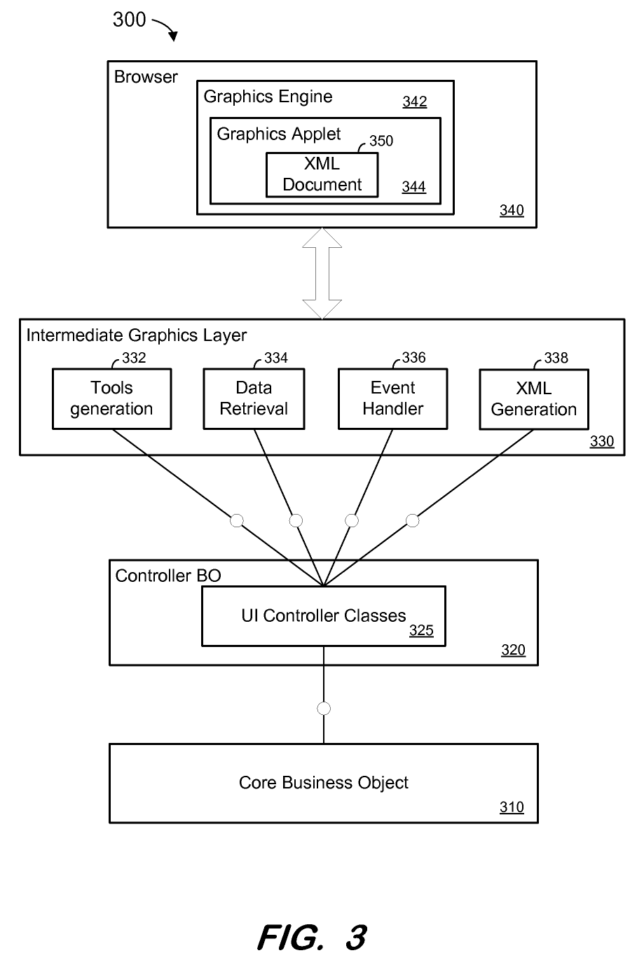

Initially, an indication of a user interface event is received at S210. The user interface event may be detected by a UI component such as UI component 115 and the indication may be transmitted thereby as well. FIG. 3 illustrates architecture 300, which is a specific example of architecture 100 of FIG. 1. Architecture 300 will be used to provide an example of process 200 according to some embodiments.

In this regard, core business object 310 provides core services to controller business object 320. Controller business object 320 contains associated UI controller classes 325. Business object 310 and controller business object 320 may therefore comprise particular implementations of business object 122 and UI controller object 124, respectively.

According to architecture 300, controller business object 320 exposes core services to intermediate graphics layer (IGL) 330. IGL 330 may include UI building blocks such as, but not limited to, tools generation module 332, data retrieval module 334, event handler 336, and eXtended Markup Language (XML) generation module 338. Operation of each of the elements of IGL 330 according to some embodiments will be described below.

IGL 330 communicates with browser 340 including graphics engine 345. Graphics engine 345 interprets XML document 350, which may have been received in whole or in part from IGL 330, and operates in conjunction with browser 340 to present a user interface based on XML document 350. Browser 340 may comprise any suitable Web browser and graphics engine 342 may comprise a Java execution engine which executes an applet 344 to interpret XML document 350. Accordingly, XML document 350 may be formatted according to any protocol supported by graphics engine 345 and/or by code executed by graphics engine. In some embodiments, document 350 is not an XML document but is instead a HyperText Markup Language (HTML) document with associated JavaScript code.

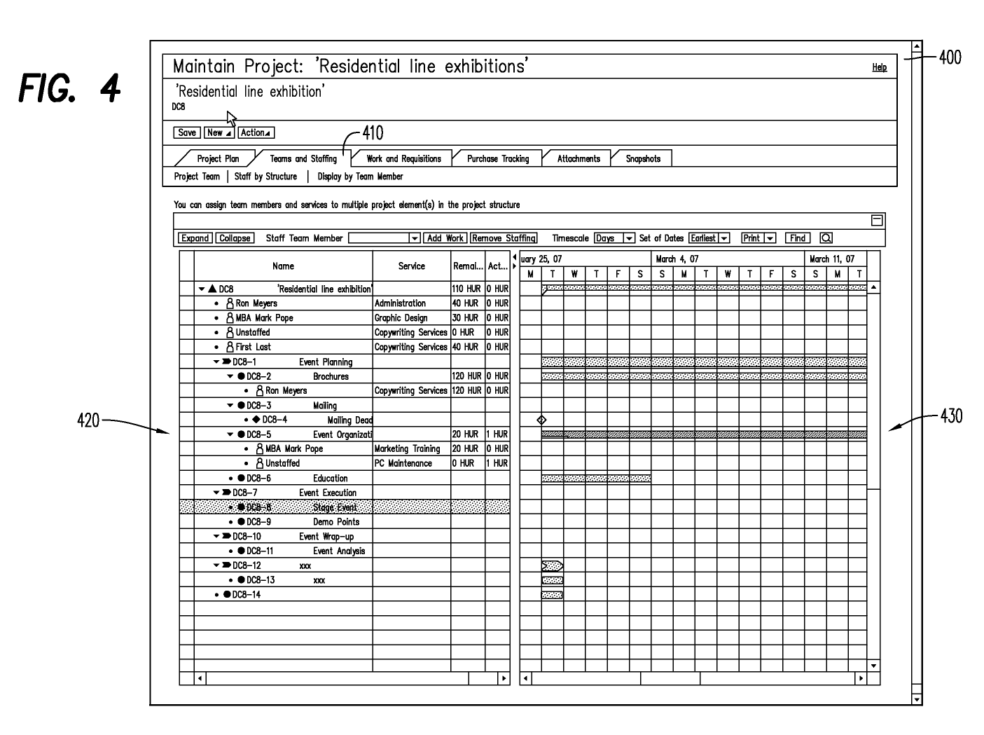

FIG. 4 is an outward view of user interface 400 that may be presented by browser 340 and graphics engine 345 according to some embodiments. User interface 400 may be presented by any suitable display device in communication with any suitable client device in which browser 340 resides. A client device may execute any suitable client application that is or becomes known to cause a display device to present user interface 400.

In some embodiments, user interface 400 comprises a main window of a web browsing application displayed on a flat panel LCD monitor coupled to a desktop computer. Examples of other client devices include, but are not limited to, a laptop computer, a personal digital assistant, a cellular telephone, and a tablet-based personal computer.

User interface 400 may be generated by XML generation module 336 based on one or more business objects such as core business object 310 as will be described in detail below. User interface 400 includes user interface controls such as buttons, tabs, and pull-down menus to select and/or manipulate data displayed by user interface 400. Such controls may also allow a user to manipulate the format and type of data displayed by user interface 400. Embodiments are not limited to the user interface layout and/or user interface controls of FIG. 4.

Teams and Staffing tab 410 of user interface 400 has been selected, resulting in display of project staffing area 420 and Gantt chart 430. Project staffing area 420 includes graphical indicators of project DC8 and project elements DC8-1 through DC8-14. Project staffing area 420 allows a user to graphically assign a person (and a service) to a project element, or task.

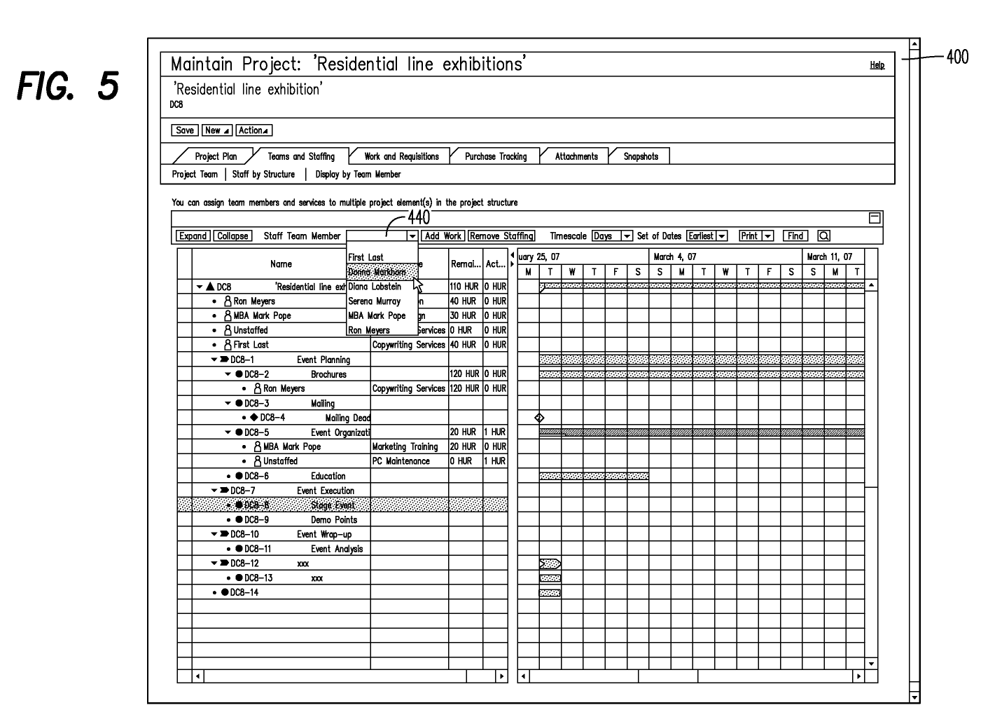

For example, as shown in FIG. 5, a user may manipulate an input device to open pull-down menu 440. Pull-down menu 440 provides a list of team members that may be assigned to a particular task. FIG. 5 also shows selection of team member “Donna Markham”. Task DC8-8 has also been selected and is highlighted during selection of team member “Donna Markham”. Accordingly, FIG. 5 may user manipulation of interface 400 in order to assign team member “Donna Markham” to task DC8-8.

The foregoing manipulation may cause graphics engine 345 to detect a user interface event such as that described with respect to S210 of process 200. Graphics engine 345 may call a Web service of IGL 330 in response to the event. IGL 330 therefore receives an indication of the user interface event at S210 and, in response, determines an instruction to assign a person to a task based on the user interface event at S220.

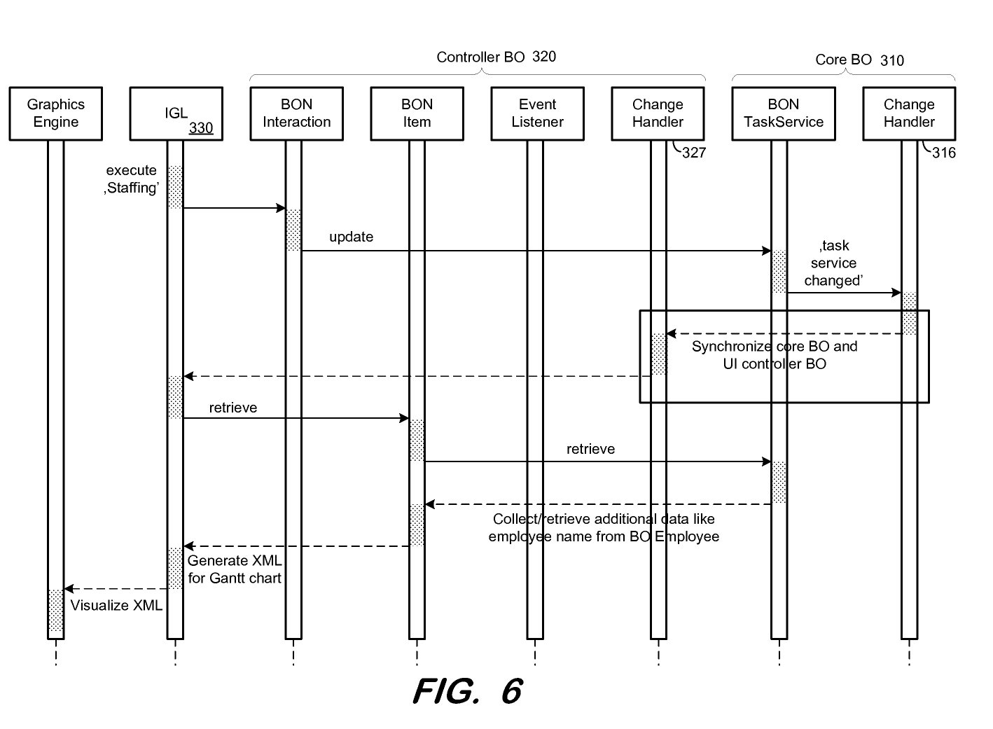

FIG. 6 is a diagram showing communication between various modules according to some embodiments of process 200 and architecture 300. As shown, IGL 330 interprets the user interface event as a Staffing instruction at S220. As described above, the user interface event illustrated in FIG. 5 comprises an instruction to assign team member Donna Markham to task DC8-8.

Next, at S230, a service of a user interface controller object is called. The service is called to assign the person to the task based on the determined instruction. FIG. 6 shows IGL 330 calling a service of controller business object 320 according to S320. The service is supported by an Interaction node of controller business object 320 according to the FIG. 6 example.

The Interaction node, in turn, calls a service of a business object associated with the task at S240. The call is intended to assign the selected person to the task. At S250, the business object is updated at S250 to assign the person to the task.

In some embodiments such as that illustrated in FIG. 6, a TaskService node of a Project business object is updated at S250. FIG. 6, in this regard, depicts updating of a TaskService node of core Project business object 310 at S250.

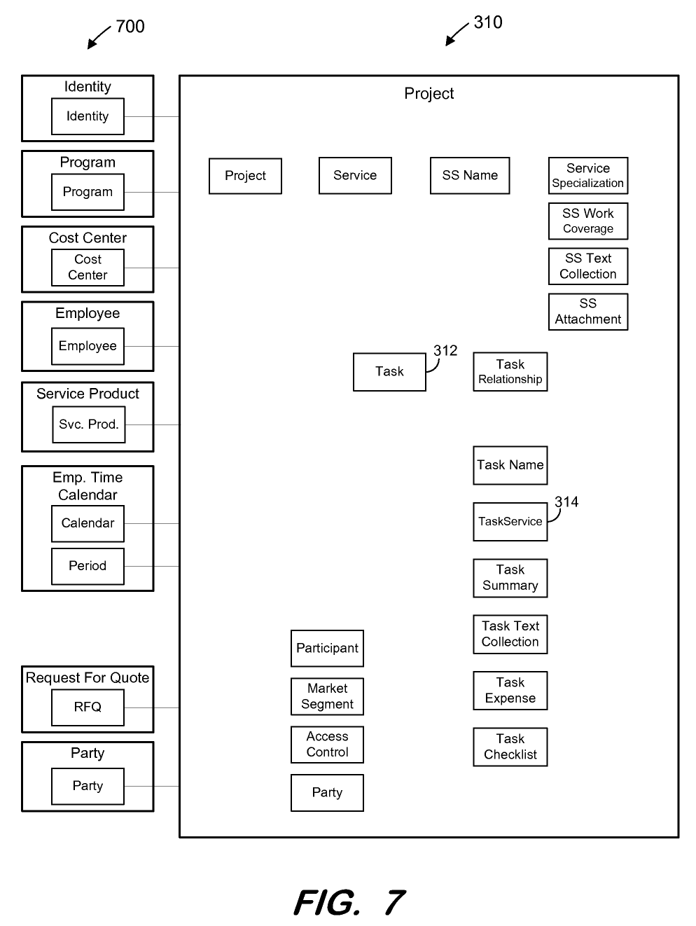

FIG. 7 illustrates general examples of Project business object 310 and other business objects 700 according to some embodiments. Objects 310 and 700 include nodes which may be interrelated with other nodes in any suitable manner. Each of objects 310 and 700 may include nodes other than those illustrated. For simplicity, FIG. 7 does not depict attributes, queries, and actions for each illustrated business object.

For purposes of the present example, Project business object 310 is assumed to be associated with project DC8 mentioned above. Moreover, according to the particular architecture of business object 310, Task node 312 is associated with task DC8-8 and TaskService node 314 specifies those persons assigned to task DC8-8. Accordingly, TaskService node 314 is updated at S250 to assign Donna Markham to task DC8-8 according to some embodiments. S250 may comprise updating other or additional nodes within Project business object 310 and/or one or more nodes of other business objects 700.

The user interface controller object is synchronized with the updated business object at S260. Change Handler 316 of core business object 310 may detect the update and interact with Change Handler 327 of controller business object 320 as shown in FIG. 6 to synchronize controller business object 320 with updated core business object 310. According to the present example, Change Handler 327 also communicates with IGL 330 to indicate the updated core business object.

A user interface is generated at S270. The user interface is to present a Gantt chart representing the updated business object. Typically, a Gantt chart comprises a bar chart illustrating start and finish dates of terminal elements of a project. A Gantt chart may also show dependent relationships between project elements. For example, a Gantt chart may represent the phases and activities of a project work breakdown structure, where a summary of terminal elements may be shown, including all of their associated activities and percentage of activities completed.

Returning to FIG. 6, IGL 330 may use services of controller business object 320 to retrieve additional data for use in generating the above-mentioned user interface. These services may provide interaction with node Item of object 320 to retrieve data from core business object 310 and/or from one of business object 700. The generated user interface may comprise an XML document.

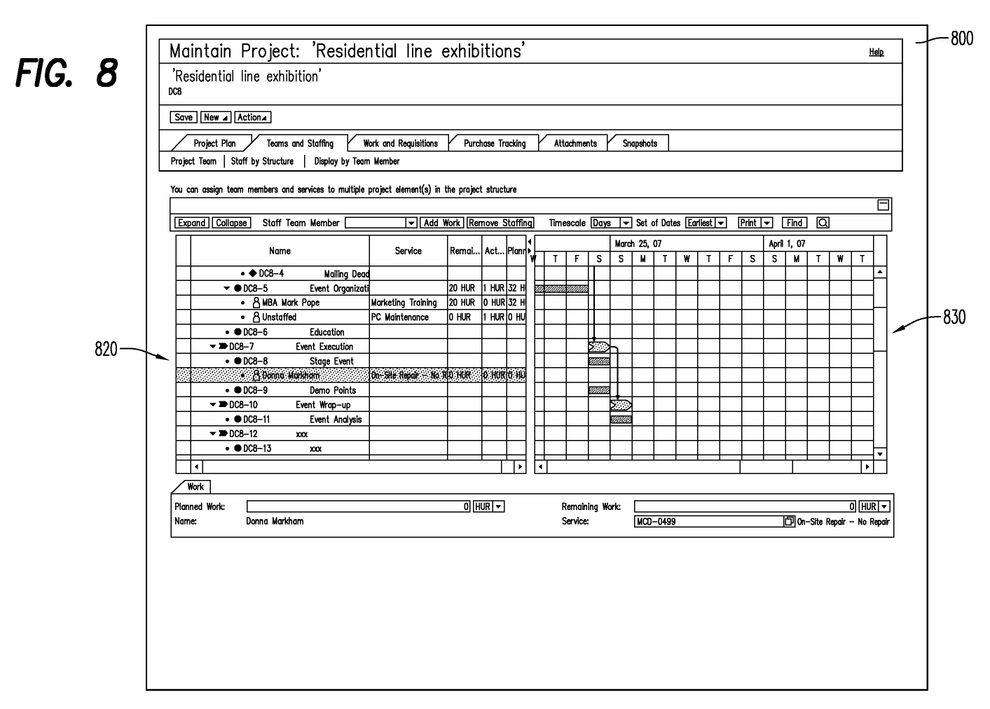

Such an XML document may be transmitted to browser 340 and interpreted by applet 344 to display the associated user interface. FIG. 8 is an outward view of user interface 800 that may be generated at S270 according to the present example. Project staffing area 820 of interface 800 graphically illustrates the above-described assignment of team member Donna Markham to task DC8-8. Moreover, Gantt chart 830 of user interface 800 reflects details of the assignment. Some embodiments may thereby provide efficient project staffing and visualization thereof using core business object data.

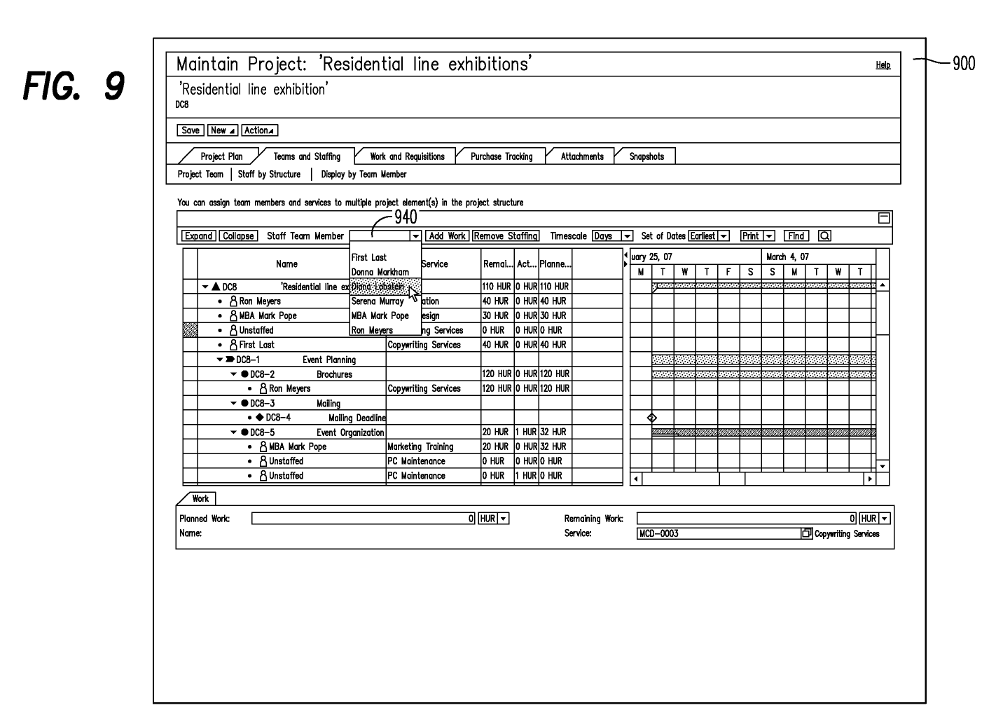

FIG. 9 illustrates another user interface event that may trigger the assignment of a person to a task. Staff team member Diana Lobstein has been selected from pull-down menu 940 while a service of main project task DC8 is selected. A user may manipulate interface 900 in this manner in order to assign the selected member to task DC8 and, more particularly, to the selected service of task DC8.

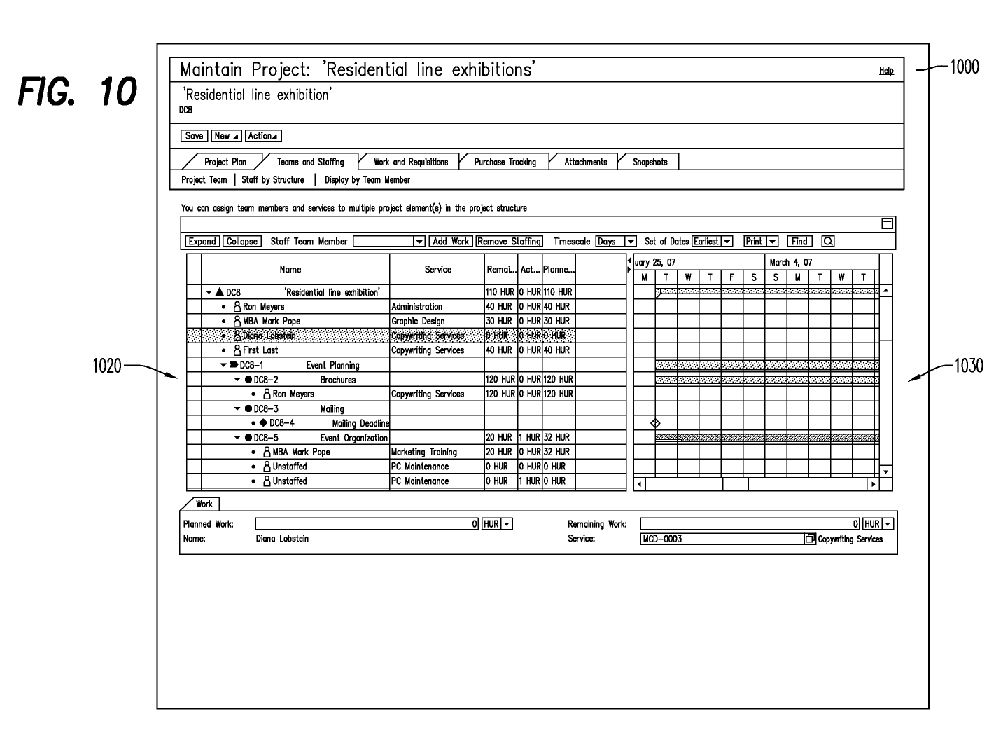

An indication of the user interface event illustrated in FIG. 9 may be received at S210 of process 200. Process 200 may then proceed as described above to update a corresponding business object and to generate a user interface including a Gantt chart. User interface 1000 of FIG. 10 is an example of such an interface. Interface 1000 includes Gantt chart 1030 and project staffing area 1020 which graphically illustrates the assignment of team member Diana Lobstein to task DC8.

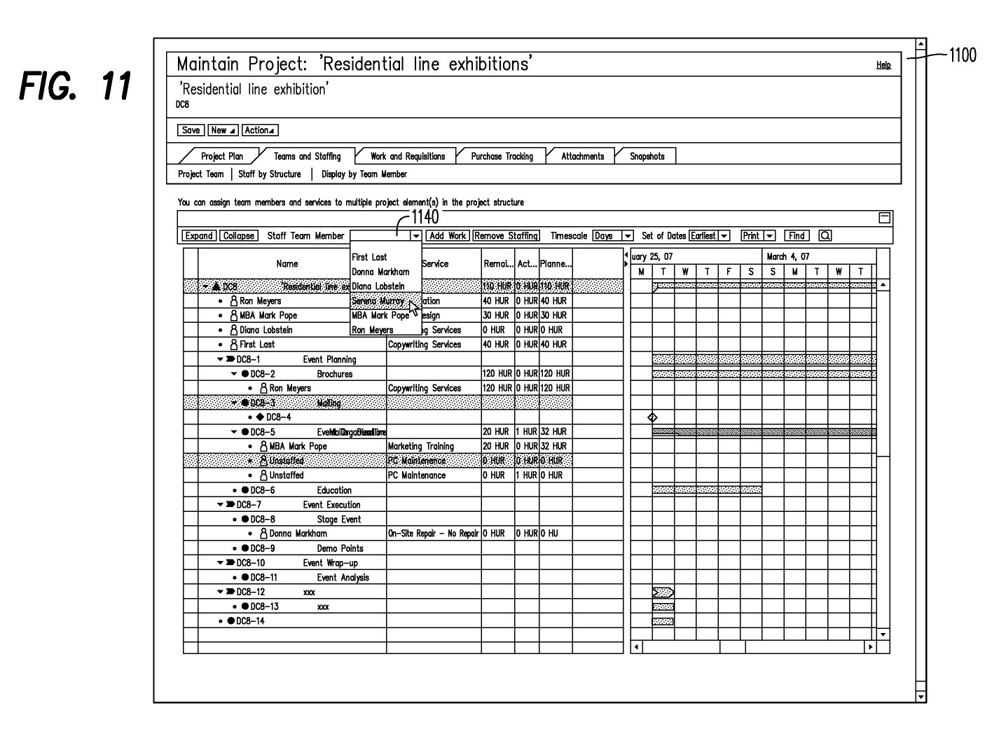

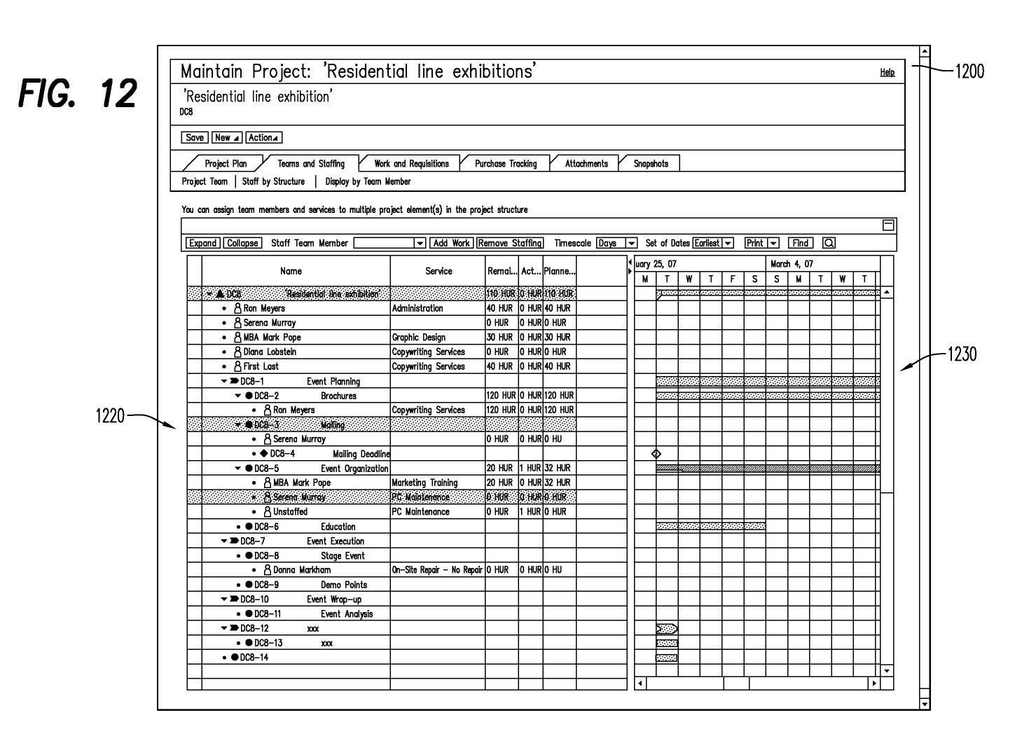

User interface 1100 of FIG. 11 illustrates another user interface event that may be used in some embodiments to assign a person to more than one task. In particular, staff team member Serena Murray has been selected from pull-down menu 940 while main project task DC8, task DC8-3, and a service of task DC8-5 are selected. An indication of the illustrated user interface event may be received at S210 of process 200. A corresponding business object is therefore updated and a corresponding user interface including a Gantt chart is generated. An example of resulting user interface 1200 is shown in FIG. 12. Again, interface 1200 includes Gantt chart 1230 and project staffing area 1220. Area 1220 graphically illustrates the assignment of team member Serena Murray to task DC8, task DC8-3, and task DC8-5.

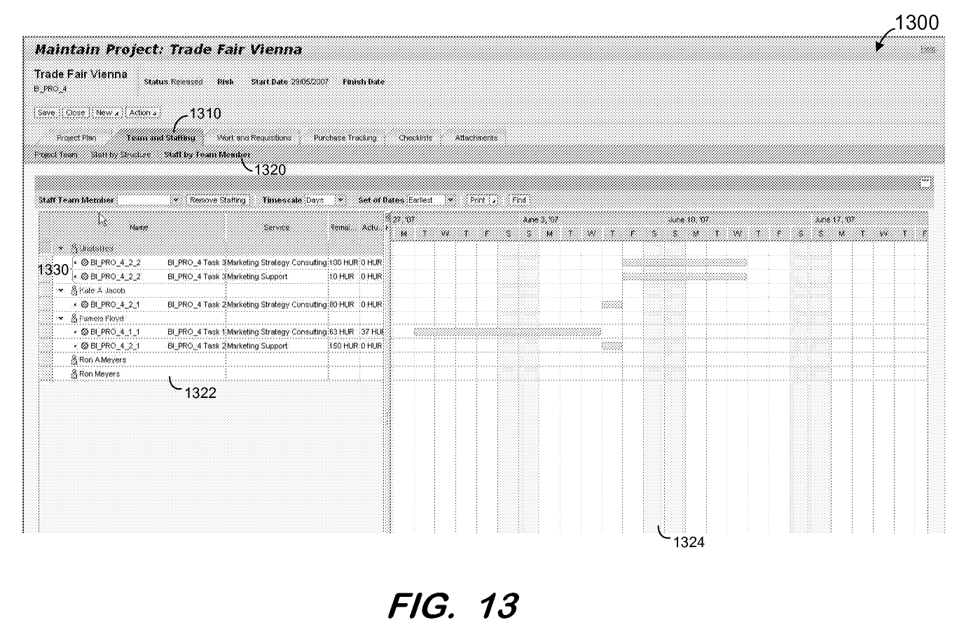

User interface 1300 of FIG. 13 also allows a user to control the assignment of a person to a task according to some embodiments. Team and Staffing tab 1310 of user interface 1300 includes Staff By Team Member sub-function 1320. Selection of sub-function 1320 results in the display of team staffing area 1322 and Gantt chart 1324.

In contrast to the project staffing areas of the above-described user interfaces, team staffing area 1322 displays one row for each team member. Beneath each row associated with a team member are rows indicating each task and related service to which the team member is assigned. Area 1322 also includes an Unstaffed row under which unassigned services and their associated tasks 1330 and are listed.

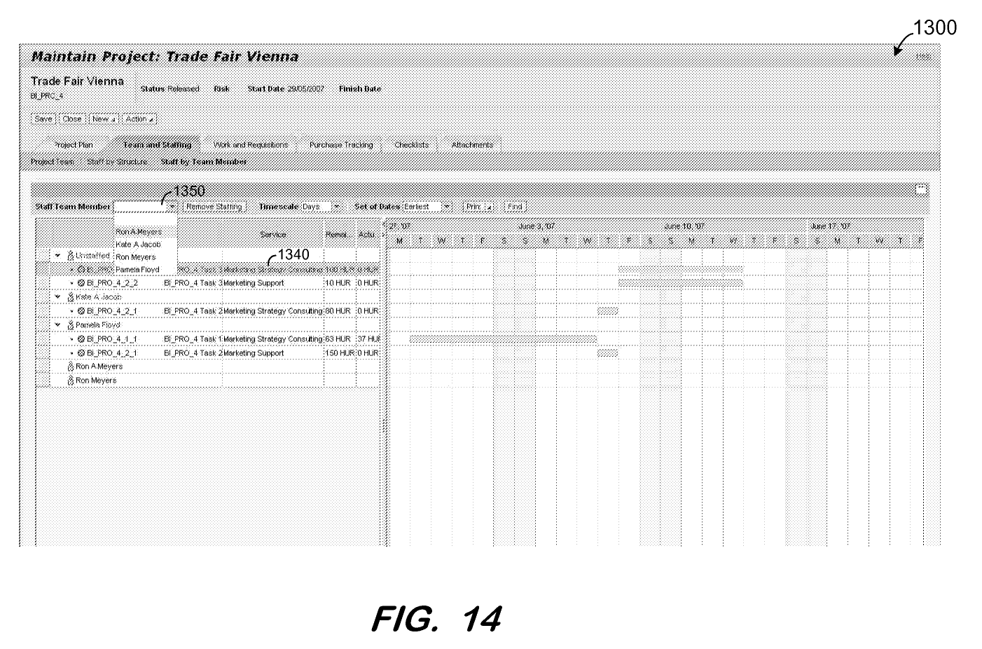

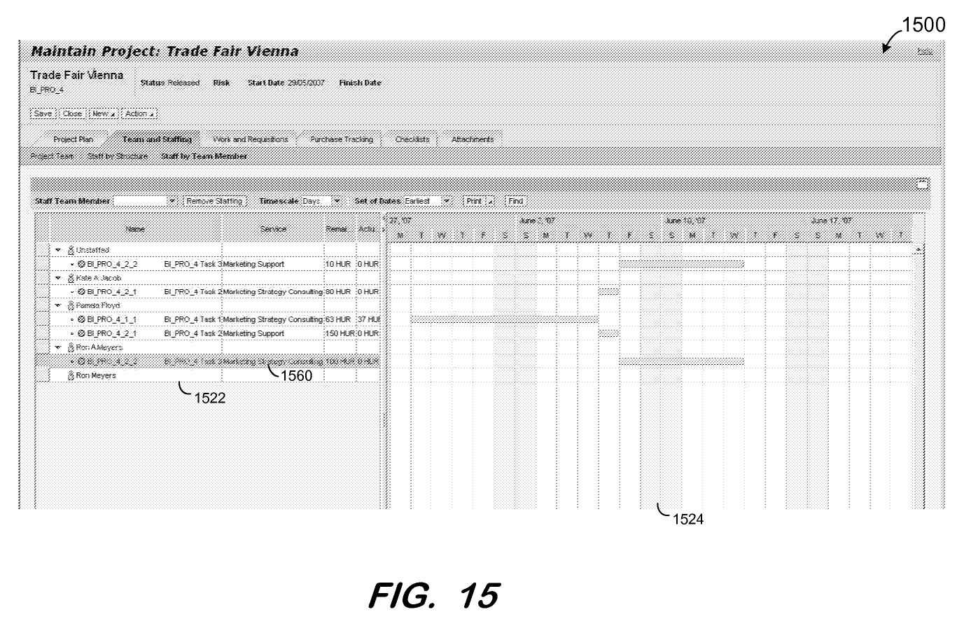

FIG. 14 illustrates manipulation of user interface 1300 to assign a person to a task according to some embodiments. FIG. 14 shows staff team member Ron A. Meyers selected from pull-down menu 1350 while unassigned service 1340 of project task BI_PRO_4 Task 3 is selected. An indication of this user interface event may be received at S210 of process 200. As described above, process 200 may then proceed to update a corresponding business object and to generate a user interface including a Gantt chart. For example, user interface 1500 of FIG. 15 includes team staffing area 1522 and Gantt chart 1524. Team staffing area 1522 includes row 1560 to graphically illustrate the assignment of team member Ron A. Meyers to project task BI_PRO_4 Task 3.

Embodiments are not limited to the above-described user interfaces or user interface events. According to some embodiments, a user interface presented by graphics applet 344 may support drag-and-drop user interface events to assign a person to a task. For example, a graphical indicator of a task service may be selected and “dropped” onto a graphical indicator of a team member and, at S220, an instruction to assign the team member to the task is determined.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method comprising:
receiving an indication of a user interface event;
determining an instruction to assign a person to a task based on the user interface event;
calling a service of a user interface controller object to assign the person to the task based on the determined instruction;
calling a service of a business object associated with the task to assign the person to the task;
updating the business object to assign the person to the task;
synchronizing the user interface controller object with the updated business object; and
generating a user interface to present a Gantt chart representing the updated business object.

2. A method according to claim 1, wherein the user interface event comprises selection of the task and selection of the person while the task is selected.

3. A method according to claim 1, wherein the user interface event comprises selection of a service associated with the task and selection of a person while the service is selected.

4. A method according to claim 1, wherein the user interface controller object maps nodes of the business object to user interface elements.

5. A method according to claim 4, wherein the user interface controller object maps nodes of the business object to elements of the Gantt chart.

6. A method according to claim 1, wherein calling the service of the business object comprises:
determining that the business object is associated with the user interface controller object.

7. A method according to claim 1, wherein updating the business object to assign the person to the task comprises:
updating a TaskService node of the business object.

8. A method according to claim 1, wherein generating the user interface comprises:
notifying user interface building blocks that the business object has been updated;
calling a service of the user interface controller object to retrieve information of the updated business object;
calling a service of the updated business object to retrieve the information;
providing the information from the updated business object to the user interface controller object; and
providing the information from the user interface controller object to the user interface building blocks,
wherein the user interface is generated by the user interface building blocks.

9. A system comprising:
a graphics engine to display a user interface, to detect user manipulation of the user interface, and to transmit an indication of a user interface event based on the user manipulation;
an intermediate graphics layer to receive the indication of the user interface event, to determine an instruction to assign a person to a task based on the user interface event, and to call a first service to assign the person to the task based on the determined instruction;
a user interface controller object to expose the first service, and to call a second service associated with the task to assign the person to the task;
a business object associated with the task, the business object to expose the second service and to update the business object to assign the person to the task,
wherein the intermediate graphics layer is to generate a second user interface including a Gantt chart representing the updated business object and to transmit the second user interface to the graphics engine, and
wherein the graphics engine is to display the second user interface.

10. A system according to claim 9, wherein the user interface event comprises selection of the task and selection of the person while the task is selected.

11. A system according to claim 9, wherein the user interface event comprises selection of a service associated with the task and selection of the person while the service is selected.

12. A system according to claim 9, wherein the user interface controller object maps nodes of the business object to user interface elements.

13. A system according to claim 12, wherein the user interface controller object maps nodes of the business object to elements of the Gantt chart.

14. A system according to claim 9, wherein the business object is to update a TaskService node of the business object to assign the person to the task.

15. A system according to claim 9, wherein user interface controller object is to notify the intermediate graphics layer that the business object has been updated, and
wherein the intermediate graphics layer is to retrieve updated information of the updated business object and to generate the second user interface based on the updated information.

16. A computer-readable medium storing processor-executable program code, the program code comprising:
code to present a user interface, the user interface comprising:
a hierarchical table including a plurality of tasks and zero or more people graphically associated with each task,
a Gantt chart associated with the plurality of tasks, and
an interface element to select one of a plurality of people to associate with one or more of the plurality of tasks,
wherein manipulation of the interface element to select a person to associate with one of the plurality of tasks results in presentation of an updated hierarchical table graphically associating the person with the one of the plurality of tasks and an updated Gantt chart representing the association of the person with the task.

17. A computer-readable medium according to claim 16, wherein the hierarchical table includes one or more services graphically associated with each task and zero or more people graphically associated with each service, and
wherein the interface element is manipulable to select one of the plurality of people to associate with one or more of the services.

18. A computer-readable medium according to claim 17, wherein manipulation of the interface element to select a person to associate with one of the services results in presentation of an updated hierarchical table graphically associating the person with the one of the services and an updated Gantt chart representing the association of the person with the service.

19. A computer-readable medium according to claim 16, wherein the program code comprises a graphics execution engine and a markup language document.
